(19) United States
(12) Patent Application Publication
(10) Pub. No.: US 2026/0350472 A1
(43) Pub. Date: Nov. 5, 2026

(54) CONTROLLABLE GUIDANCE FOR GENERATIVE ARTIFICIAL INTELLIGENCE MODEL

(71) Applicant: Stability AI Ltd, London (GB)

(72) Inventors: Zachary Novack, San Diego, CA (US); Zach Evans, Bellevue, WA (US); Zachary Zukowski, Sacramento, CA (US); Josiah Taylor, Stafford (GB); Julian Parker, London (GB); Jordi Pons, Sabadell (ES); CJ CARR, Medford, MA (US)

(73) Assignee: Stability AI Ltd, London (GB)

(21) Appl. No.: 19/667,349

(22) Filed: May 4, 2026

Related U.S. Application Data
(60) Provisional application No. 63/800,230, filed on May 5, 2025.

(30) Foreign Application Priority Data
May 2, 2025 (EP) EP25382450.2

(51) Int. Cl. G06N 20/00; G10H 1/00

(52) U.S. Cl. CPC G06N 20/00; G10H 1/0025; G10H 2210/111

(57) ABSTRACT

Techniques include receiving a first latent space representation, the first latent space representation generated based at least in part on inputting a prompt indicating a feature of first content to a first model. Techniques further include generating, by the first model, a modified latent space representation by modifying the first latent space representation based at least in part on the feature of the first content. Techniques further include generating, using the modified latent space representation and the first model, second content that is different from the first content, wherein the second content represents the feature.

### CROSS REFERENCE TO RELATED APPLICATIONS

This application claims the benefit of and priority to U.S. Provisional Application No. 63/800,230, filed May 5, 2025, and titled “Controllable Guidance for Generative Artificial Intelligence Model,” the content of which is herein incorporated by reference in its entirety for all purposes. This application also incorporates by reference for all purposes in its entirety paper publication “Low-Resource Guidance for Controllable Latent Audio Diffusion” to Novack et al., arXiv:2603.04366 [cs.SD] 4 Mar 2026.

### BACKGROUND

Artificial intelligence models (e.g., generative artificial intelligence models) have gained mainstream attention recently for their capabilities. Despite the impressive progress that has been made in the field of machine learning, existing techniques for training artificial intelligence models and use cases of artificial intelligence models could be further improved.

### BRIEF DESCRIPTION OF THE DRAWINGS

Features, embodiments, and advantages of the present disclosure are better understood when the following Detailed Description is read with reference to the accompanying drawings.

FIG. 1 is a block diagram illustrating an example controllable guidance system, according to certain embodiments.

FIG. 2 is a block diagram illustrating an example controllable guidance system, according to certain embodiments.

FIG. 3 is a block diagram illustrating an example diffusion system, according to certain embodiments.

FIG. 4 is a block diagram illustrating an example latent-control head model, according to certain embodiments.

FIG. 5 is a block diagram illustrating an example process using a controllable guidance system, according to certain embodiments.

FIG. 6 is a block diagram illustrating an example method of using a controllable guidance system, according to certain embodiments.

FIG. 7 is a block diagram of an exemplary computer apparatus, according to certain embodiments.

### DETAILED DESCRIPTION

Certain embodiments describe techniques for generating second content based on an input comprising a prompt and a feature of first content by generating a modified latent space representation. The system may generate a modified latent space representation by applying a guidance signal derived from a latent-control head directly to the modified latent space representation, thereby nudging the generative process to align with the feature. This capability is valuable across a range of applications and industries, including computer vision, graphics, artificial intelligence (AI), music production, gaming, augmented reality (AR), and virtual reality (VR).

The generation of high-fidelity digital assets through generative models, such as diffusion, transformer, or flow-matching architectures, may present a fundamental conflict between precise user control and computational efficiency. While these models can synthesize high-quality content, they often operate as "black boxes" that lack fine-grained steerability. Current methods for controlling these models often require a "generate-and-check" cycle that is computationally expensive and slow, as the system must often decode the data into a perceptible format before adjustments can be made.

This can create a "control gap" where specific structural, temporal, or stylistic features cannot be easily navigated or modified during the generative process. Certain embodiments described herein can identify and isolate specific feature subspaces within a latent manifold to provide real-time, low-resource guidance. By steering the generative process directly within the latent-domain, the present invention can enable precise adherence to a user’s intent or desire, such as specific pitch contours, visual textures, or geometric layouts, independent of the final asset reconstruction, thereby maximizing creative precision, processing speed, and/or resource (e.g., memory, energy, processing, network) usage.

The challenges in providing precise control during the generative process may stem from the high dimensionality and complexity of the raw data. Conventional solutions often attempt to calculate guidance signals within the output signal space, such as the final waveform or pixel grid. This approach requires the system to fully decode a noisy latent representation into a perceptible format at every step of the iterative diffusion process to measure its features against a target state. Because decoders and feature extractors are computationally demanding, this method can be resource-intensive and often requires significant hardware acceleration for a single generation.

Other alternative solutions may involve fine-tuning the entire generative model for a specific control task. However, this approach often lacks flexibility and can degrade the general creative capabilities of the model because the optimization process for the specific control task can lead to forgetting' or a shift in the model's global weights, effectively narrowing the distribution of outputs the model can generate. Thus, a more efficient system that can provide granular control without the overhead of full reconstruction or the rigidity of task-specific fine-tuning can be beneficial. The techniques described herein can solve problems that existed with previous techniques by isolating and steering specific feature subspaces directly within the latent manifold, allowing for high-precision guidance that remains resource efficient.

The described techniques can address inadequacies in previous solutions by introducing a more computationally efficient system for controllable generation through the use of latent-control head models. Unlike systems that may require decoding into a final output space (e.g., output domain, signal space, etc.), the latent-control head model is a lightweight architectural component designed to identify and predict features directly within the latent representation. By comparing against a target feature state within this latent space, the system can derive a guidance signal, such as a gradient, to steer the denoising trajectory toward a targeted or desired output.

This framework can allow the primary generative model to remain frozen and unmodified while enabling modular, real-time control over diverse characteristics. Because the system operates at the latent level and avoids backpropagation through the weights of the base model, it can preserve high-speed inference. This approach can enable the precise manipulation of features without the computational overhead traditionally associated with high-fidelity steerable generation.

The techniques described herein can provide a system for controlling generative artificial intelligence without the high computational costs typically required for such tasks. While modern artificial intelligence models can generate high-quality content, they are often difficult to "steer" toward specific structural goals, such as a precise melody or a specific visual layout. Many existing solutions address this by fully decoding the artificial intelligence model’s internal data into a final format, such as a waveform or an image, to check for accuracy. This conventional approach is often slow and resource-heavy because it requires constant translation of complex data during the generation process.

The present techniques can overcome these limitations by introducing a specialized latent-control head. This component operates directly within the artificial intelligence model’s internal, latent data domain, known as the latent representation. Because this space is mathematically streamlined, the techniques can isolate and identify specific features like pitch, rhythm, or texture with high efficiency.

By providing guidance entirely within this latent space, the techniques can steer the generative process toward a user's intent in real time. This modular approach allows the primary artificial intelligence model to remain frozen and unmodified, preserving its original creative capabilities while adding granular control. The result is a faster method for generating high-fidelity content that adheres to user-defined structural constraints while using less processing power and memory.

### I. SYSTEM ARCHITECTURES

Systems described herein may include systems for training and using various models (e.g., a diffusion model, a latent-control head model, an encoder, etc.) and systems. The various models and systems may be used to provide a controllable guidance system that can generate output based on input. One or more systems and/or models may be included in a controllable guidance system. The models may be trained as described herein.

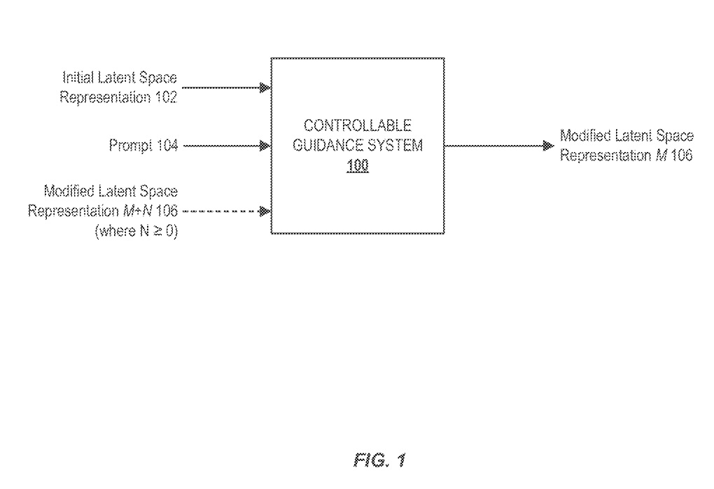

FIG. 1 is a block diagram illustrating an example controllable guidance system 100, according to certain embodiments. The controllable guidance system 100 may be configured to generate a modified latent space representation 106 for a given timestep M based on an initial latent space representation 102 and prompt 104. The controllable guidance system 100 may operate iteratively and so may optionally receive a modified latent space representation 106 generated at a timestep M+N, where N is greater than or equal to 0, repeating the process to generate a further refined modified latent space representation 106.

For the sake of clarity and to avoid descriptive redundancy, the specific operations and data flows associated with the modified latent space representation 106 at timestep M+N are not explicitly illustrated in every instance. However, it should be understood by one of ordinary skill in the art with the benefit of the present disclosure that the technical descriptions, transformations, and operations explained with reference to the modified latent space representation 106 at timestep M are equally applicable to any modified latent space representation 106 at timestep M+N, where N is greater than or equal to 0. Accordingly, the modified latent space representation 106 may refer to any specific instance or iteration of the modified data as it exists at any timestep M or M+N, where N is greater than or equal to 0.

The initial latent space representation 102 and/or the modified latent space representation 106 may refer to a data structure, such as feature embeddings or latent vectors, generated by the controllable guidance system 100. Additionally, the initial latent space representation 102 and/or modified latent space representation 106 may represent or encode content or an asset, such as an audio signal or a visual asset, such as an image or video. The initial latent space representation 102 and/or the modified latent space representation 106 may be received from a system separate from the controllable guidance system 100, such as a noise generator, an external generative model, or a data storage repository.

The initial latent space representation 102 may include “pure noise,” as in isotropic Gaussian noise. In such embodiments, the controllable guidance system 100 may receive a high-entropy data structure that lacks any discernible pattern or feature. For example, the initial latent space representation 102 may be generated by sampling a vector from a standard normal distribution where each element is independently and identically distributed, providing a stochastic "blank canvas."

Additionally or alternatively, the initial latent space representation 102 and/or the modified latent space representation 106 may include a pre-existing latent space representation associated with a specific content or asset, such as an encoded audio or visual sample. For example, the initial latent space representation 102 and/or the modified latent space representation 106 may include an embedding of the content associated with the prompt 104, such as an audio sample or visual asset. Additionally or alternatively, the initial latent space representation 102 and/or the modified latent space representation 106 may be generated based on content provided separately from the prompt 104. In some embodiments, the embedding may include diffused with Gaussian noise to introduce a degree of stochasticity, or “noise,” in order to be effective at allowing a model to iteratively refine and steer the initial latent space representation 102 and/or the modified latent space representation 106 toward a new target feature state, as will be further described herein.

The initial latent space representation 102 and/or the modified latent space representation 106 can be generated to be a lower dimensional representation as compared to the decoded output. To illustrate, the initial latent space representation 102 and/or the modified latent space representation 106 may include a compressed feature embedding or vector that represents the underlying features of an audio signal or visual asset at a fraction of its raw data size (e.g., a 128-dimensional embedding, in certain embodiments). This reduced dimensionality can ensure that the controllable guidance system 100 can perform gradient calculations and feature predictions with lower memory and latency requirements as compared to a system that requires backpropagating through a decoder or feature extraction operating in a high-dimensional audio signal or visual asset space.

The prompt 104 may be received from a user device, a user interface, a system external to the controllable guidance system 100, and/or a data storage repository. In some embodiments, the prompt 104 may include natural language text and may specify a query or a request. Alternatively, or additionally, the prompt 104 may comprise machine-readable instructions.

In some embodiments, the prompt 104 can indicate or include specific content, such as an audio signal or a visual asset. The prompt 104 may indicate a feature associated with this content. The prompt 104 may include instructions to modify the feature associate with the content. For example, the prompt 104 may comprise a natural language request stating, “modify the pitch to be higher,” and further include an audio sample of a specific song. In this example, the content is the audio sample, and the feature indicated by the prompt 104 is the pitch. The prompt 104 includes instructions to increase the pitch of the audio sample. For a prompt 104 where the content is a visual asset, the prompt 104 may comprise a natural language request stating, “modify the lighting to be more dramatic.” In this example, the content is the visual asset, the feature indicated by the prompt 104 is the lighting, and the instructions are to dramatize the lighting. Other possible features can include audio intensity, beat of an audio sample, rhythmic pattern, timbre, texture, spatiality, reverb, vibrato, articulation, loudness, dynamics. Additional possible features can include luminance, lighting, composition, color palette, saturation, depth of field, proportions, geometric complexity, materiality, or symmetry.

In some embodiments, the prompt 104 can serve as a multi-modal control signal that defines one or more target characteristics for the controllable guidance system 100 to use in the generative process to steer toward the desired output. For instance, the prompt 104 may simultaneously provide a natural language description of a musical genre and a symbolic Musical Instrument Digital Interface (MIDI) file that dictates a specific melodic progression for the output to follow. Beyond natural language text, the prompt 104 may include content. The content may include structural metadata, such as symbolic musical notation (e.g., MIDI data), spectral envelopes, video content, three-dimensional content, or rhythmic patterns. A spectral envelope can be a curve that outlines the overall shape of an audio signal's spectrum by connecting the peaks of its frequency components, effectively representing the timbre or "color" of the sound. A rhythmic pattern can be a specific sequence of musical events, such as beats or notes, arranged in time to create a structured and recurring durational framework.

In some embodiments, the controllable guidance system 100 may utilize an encoder to transform the prompt 104 into a high-dimensional embedding. The encoder may comprise a pre-trained transformer-based model, such as a CLIP (Contrastive Language-Image Pre-training) or T5 (Text-to-Text Transfer Transformer) encoder, which projects the user’s input into a continuous vector space.

The controllable guidance system 100 may generate a modified latent space representation 106 at a timestep M based on the initial latent space representation 102 and the prompt 104. The controllable guidance system 100 may generate a subsequent modified latent space representation 106, where the subsequent modified latent space representation 106 may be based on received modified latent space representation 106 generated at timestep M+N, where N is greater than or equal to 0. The modified latent space representation 106 may refer to a state of the data that has been modified or adjusted to align with specific target features while remaining within the same latent space as the initial latent space representation 102. As an example, where the prompt 104 specifies a target musical chord, the modified latent space representation 106 may comprise a vector wherein specific latent dimensions associated with harmonic or spectral characteristics are modified toward a state that represents the target musical chord. Similarly, for visual assets, the modified latent space representation 106 may represent a specific lighting configuration if the prompt 104 specified a target lighting configuration.

In some embodiments, the controllable guidance system 100 may also be configured to modify other types of assets or content, such as graphics, multi-dimensional models, animations, or other data structures, in response to prompts 104 specifying corresponding target features. For example, the controllable guidance system 100 may adjust geometric, textural, or spatial attributes of a multi-dimensional model, or modify visual elements within graphics to achieve a desired feature state or functional outcome as indicated by the prompt 104.

It should be noted that the modified latent space representation 106 may refer to a modified state during any timestep of an iterative denoising loop executed by the controllable guidance system 100. The modified latent space representation 106 may also refer to a final modified latent space representation 106 at the conclusion of the process executed by the controllable guidance system 100. Once the controllable guidance system 100 reaches the final timestep of the process, the final modified latent space representation 106 may be passed to a decoder (e.g., a Variational Autoencoder (VAE) decoder, a high-fidelity vocoder) to be transformed into a human-perceivable content or asset, such as a synthesized audio waveform or an image.

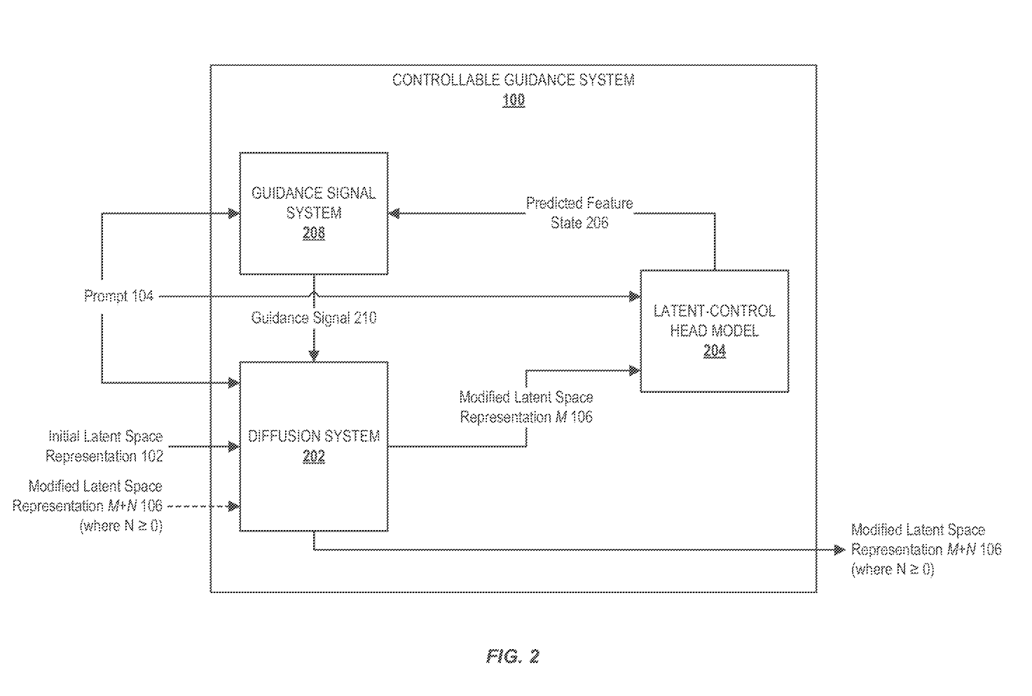

FIG. 2 is a block diagram illustrating an example controllable guidance system 100 (e.g., controllable guidance system 100 described above), according to certain embodiments. The controllable guidance system 100 may comprise a diffusion system 202, a latent-control head model 204, and a guidance signal system 208.

The controllable guidance system 100 may receive an initial latent space representation 102 (e.g., initial latent space representation 102 described above) and a prompt 104 (e.g., prompt 104 described above). The controllable guidance system 100 may generate a modified latent space representation 106 at timestep M (e.g., modified latent space representation 106 described above) based on the initial latent space representation 102 and prompt 104. The controllable guidance system 100 may optionally receive and utilize a modified latent space representation 106 generated at a timestep M+N, where N is greater than or equal to 0, as the basis for generating a subsequent modified latent space representation 106.

For the sake of clarity and to avoid descriptive redundancy, the specific operations and data flows associated with the modified latent space representation 106 at timestep M+N are not explicitly illustrated in every instance. However, it should be understood by one of ordinary skill in the art that the technical descriptions, transformations, and operations explained with reference to the modified latent space representation 106 at timestep M are equally applicable to any modified latent space representation 106 at timestep M+N, where N is greater than or equal to 0. Accordingly, the modified latent space representation 106 may refer to any specific instance or iteration of the modified data as it exists at any timestep M or M+N, where N is greater than or equal to 0.

The diffusion system 202 may receive the initial latent space representation 102 and the prompt 104. Additionally or alternatively, the diffusion system 202 may receive a guidance signal 210. The diffusion system 202 may receive a modified latent space representation 106 generated at a timestep M+N, where N is greater than or equal to 0. The diffusion system 202 may be configured to operate directly on the initial latent space representation 102 by modifying or adjusting the position of the initial latent space representation 102 within the latent space, as will be discussed in greater detail herein. Similarly, the diffusion system 202 may be configured to operate directly on the modified latent space representation 106 by modifying or adjusting the position of the modified latent space representation 106 within the latent space, as will be discussed in greater detail herein. The diffusion system 202 may include a model, such as a latent diffusion model (LDM), a diffusion transformer (DiT), autoregressive model, flow-matching model, variational autoencoder (VAE), or a generative adversarial network (GAN).

In some embodiments, the diffusion system 202 may utilize cross-attention mechanisms to integrate a high-dimensional embedding of the prompt 104 with the initial latent space representation 102 and/or modified latent space representations 106. In this process, the diffusion system 202 can generate queries (Q) from the initial latent space representation 102 and/or modified latent space representations 106, while the prompt 104 may be projected into keys (K) and values (V). By calculating the compatibility (i.e., attention scores) between the queries and the prompt 104 keys, the diffusion system 202 can determine which specific aspects of the prompt 104 (e.g., specific musical textures, visual motifs) should be emphasized within the initial latent space representation 102 and/or modified latent space representations 106 at a given timestep. This integration can allow the diffusion system 202 to attend to specific semantic tokens within the prompt 104 while denoising the latent embedding.

The diffusion system 202 can be configured to transform the initial latent space representation 102 (or a previously generated modified latent space representation 106) into a subsequent modified latent space representation 106 by conditioning the transformation process on the prompt 104. As discussed herein, the prompt 104 may comprise natural language instructions and may specify or otherwise indicate content and one or more features associated with said content toward which the instructions are directed. In some embodiments, the prompt 104 may be multimodal, comprising a combination of natural language instructions, reference content, and specific feature parameters. These multimodal inputs can serve to inform the diffusion system 202 how to shift or transform the initial latent space representation 102 (or a previously generated modified latent space representation 106) to satisfy the requirements natural language instructions of the prompt 104. For example, the prompt 104 may include natural language instructions to shift the octave of a vocal performance, provided alongside reference content comprising a different vocal sample recorded in the target octave. The diffusion system 202 can be configured to extract acoustic parameters from the reference content and utilize said parameters as a structural guide to steer the initial latent space representation 102 (or a previously generated modified latent space representation 106) toward a target state corresponding to the desired octave.

Once generated, the modified latent space representation 106 may be transmitted to the latent-control head model 204. Utilizing the inputted modified latent space representation 106, the latent-control head model 204 may generate a predicted feature state 206 based on the modified latent space representation 106.

The latent-control head model 204 may operate as a specialized collaborative model that is pre-trained to identify a specific subspace within the modified latent space representation 106 that corresponds to the targeted or desired feature state of the content. From these specific identified subspaces, the latent-control head model 204 may then distill the latent data into a predicted feature state 206. In other words, the latent-control head model 204 may analyze the dimensions of the modified latent space representation 106 to identify the specific vector direction or manifold coordinates associated with the feature in question. Manifold coordinates can refer to a specific location on a complex, curved surface (i.e., a latent manifold) that represents the valid variations of a piece of data. A latent manifold can refer to a lower-dimensional mathematical surface embedded within a high-dimensional space that captures the essential structure and relationships of complex data. This is particularly useful for high-dimensional latent data, which does not uniformly occupy the entire available high-dimensional space, but is instead constrained to a lower-dimensional subspace of meaningful features, such as acoustic timbre, harmonic structures, temporal cadences, etc. For example, if the prompt 104 specifies an increase in pitch, the latent-control head model 204 may probe the modified latent space representation 106 via certain techniques (e.g., manifold mapping, latent linear probing) to isolate the location (e.g., specific vector direction, manifold coordinate, or subspace) that governs pitch, thereby identifying the transformation required to achieve the target feature state.

After isolating the relevant manifold coordinates or vector direction associated with the requested feature, the latent-control head model 204 can project these localized latent dimensions into a lower-dimensional feature space to generate the predicted feature state 206. The projection into the lower-dimensional feature space can serve to disentangle the targeted feature from unrelated latent attributes. Take for example a prompt 104 that specifies that the pitch of a piece of audio content is to be increased. The high-dimensional latent embeddings associated with the audio content can often contain entangled representations in which the pitch is mathematically intertwined with other features in the audio content, such as timbre, rhythm, or spatiality.

To address the entangled representations, the latent-control head model 204 can distill, from the modified latent space representation 106, the isolated manifold coordinates or the vector direction for the target feature into a lower-dimensional feature domain. From this projection of the isolated manifold coordinate or the vector direction, the latent-control head model 204 can determine the predicted feature state 206. In one example, where the feature indicated by the prompt 104 is pitch, the subspace of the modified latent space representation 106 associated with pitch is isolated and projected into the lower-dimensional feature domain. Within this domain, the predicted feature state 206 can be directly and quantitatively compared to the target feature state associated with the requested pitch, as both states exist within the same dimensional space. Operating within this domain can enable low-resource guidance as it can eliminate the requirement to backpropagate through a decoder to determine the difference between the target feature state and the predicted feature state 206. This dimensionality reduction may also serve to filter out latent 'noise' from unrelated features, ensuring that the resulting guidance signal 210 is highly specific to the requirements of the prompt 104. Consequently, the controllable guidance system 100 can steer the modified latent space representation 106 toward the target feature state while preventing unwanted modifications in non-targeted dimensions of the content.

In some embodiments, the latent-control head model 204 may be configured to modify the predicted feature state 206 by combining it with a noise signal to generate a noisy predicted feature state 206. The noise signal may include the predicted features state 206 prior to the determination of the difference (e.g., via the guidance signal system 208). In some embodiments, adding the noise signal may involve the injection of Gaussian noise directly into the dimensions of the predicted feature state 206. This intentional addition of noise is done to prevent the guidance signal 210 from over-fitting or "brittle." By calculating the guidance signal 210 based on a noisy version of the predicted features state 206, the controllable guidance system 100 can ensure that the steering logic accounts for a statistical margin of error, which can improve the robustness of the modifications for subsequent modified latent space representations 106. This may also prevent the denoising process from collapsing into narrow, repetitive solutions and instead can encourage a more natural, generalized convergence toward the target feature state.

In some embodiments, the controllable guidance system 100 can be configured to perform randomized averaging of the guidance signal 210 to protect the structural integrity of the generated content. For example, instead of calculating a single direction from a single modified latent space representation 106, the latent-control head model 204 may generate a plurality of variations by adding random noise (e.g., Gaussian noise) to a predicted clean latent space representation. This predicted clean representation serves as the high-dimensional precursor from which the predicted feature state 206 is identified. The latent-control head model 204 can proces each of these noisy variations of the modified latent space representation 106 to produce a corresponding plurality of predicted feature states 206. The guidance signal system 208 may then calculate the error (e.g., loss) for each individual variation relative to the target feature state and combines these errors (e.g., by averaging or summation) to derive the guidance signal 210 as a stable and reliable direction for the generation process. This multi-sample approach prevents the denoising process from becoming erratic or stuck in repetitive, low-quality patterns.

The latent-control head model 204 may transmit the predicted feature state 206 to the guidance signal system 208. The guidance signal system 208 may receive the prompt 104 or may reference content or other assets provided therein prompt 104 that indicate the targeted or desired feature state of the content. The guidance signal system 208 may generate, based on the predicted feature state 206 and/or the prompt 104, a guidance signal 210. In some embodiments, the latent-control head model 204 itself may be configured to perform the operations of the guidance signal system 208. In such embodiments, the latent-control head model 204 may receive the prompt 104 directly or may reference content or other assets provided therein prompt 104 to extract the target feature state requirements, calculate the discrepancy between the current and target feature state, and/or output the guidance signal 210 to the diffusion system 202.

To reiterate, the target feature state may be derived from the prompt 104 through several means. In one embodiment, the state is extracted from natural language text instructions included within the prompt 104. In other embodiments, the target feature state may be provided as an external asset or reference content within the prompt 104, such as a digital audio file or an image file that serves as a representation of the desired feature state.

The target feature state may be represented as a multidimensional vector, where each dimension corresponds to a specific feature or attribute. This can allow the controllable guidance system 100 to simultaneously target multiple modifications (e.g., simultaneous adjustments to both 'tempo' and 'reverberation') by establishing a composite objective within the lower-dimensional feature domain. Additionally or alternatively, the target feature state can be time-varying. For example, the prompt 104 may include instructions or automation data that specify different target feature states for different segments of the audio content. In such scenarios, the guidance signal system 208 may dynamically update the target feature state in synchronization with the temporal position (i.e., the specific timestep M or N) of the denoising process.

The extraction of the target feature state from the prompt 104 may involve a mapping function that translates qualitative descriptors from the prompt 104 into quantitative values. For instance, a natural language prompt 104 for “snazzier” audio may be mapped to a target feature state that specifies an increased energy distribution in the upper-mid and high frequency bands to enhance clarity, as well as an emphasis on staccato articulations to increase the perceived rhythmic sharpness of the audio content.

The guidance signal system 208 may determine a discrepancy between the predicted feature state 206 and the target feature state to generate the guidance signal 210. In some embodiments, the guidance signal system 208 may utilize an objective function, such as a distance metric or loss function, to quantify the difference between the predicted feature state 206 and the target feature state. Based on this quantification, the guidance signal system 208 can calculate a gradient of the objective function with respect to the modified latent space representation 106. This gradient can represent the optimal trajectory within the latent manifold to satisfy the parameters of the prompt 104.

Structurally, the guidance signal 210 may be represented as a conditioning tensor or a vector of additive residuals that are applied to the latent data. Rather than replacing the latent data within the modified latent space representation 106, the guidance signal 210 can function as a steering force that biases the diffusion process in the diffusion system 202. For example, the guidance signal 210 may be utilized by the diffusion system 202 to re-weight attention maps corresponding to the specific dimensions associated with the feature identified in the prompt 104. In some embodiments, the guidance signal 210 may be configured to affect a plurality of features simultaneously. In such instances, the guidance signal 210 may represent a composite value derived from the discrepancies between each respective predicted feature state 206 and its corresponding target feature state. For example, the guidance signal 210 may include a weighted average or an aggregated gradient of these individual differences, thereby allowing the diffusion system 202 to steer the modified latent space representation 106 toward a multi-objective target state in a single iteration.

In some embodiments, a scaling factor may be applied to the guidance signal 210 to modulate the magnitude of its influence on the denoising system 302. This scaling factor, which may include a scalar value or a weight vector, can determine the "strength" of the guidance signal 210 relative to the standard denoising process. By adjusting this factor, the controllable guidance system 100 can control the extent to which the resulting content conforms to the prompt 104 versus the original initial latent space representation 102. For instance, a high scaling factor may force a radical transformation to meet the prompt’s 104 specific request, while a lower scaling factor allows the controllable guidance system 100 to prioritize the structural integrity and original characteristics of the original content, ensuring that the modifications remain subtle and natural. Therefore, this scaling factor can allow for a tunable "guidance scale" that provides a granular control mechanism when applying the guidance signal 210.

In some embodiments, the guidance signal 210 may be configured using a guidance parameter associated with mean guidance. For instance, the guidance signal 210 may be integrated with a mean guidance parameter to enable the diffusion system 202 to shift the initial latent space representation 102 and/or the modified latent space representation 106 toward the target feature state, thereby “steering” the directional evolution of the content in accordance with the prompt 104. Additionally or alternatively, the guidance signal 210 may be configured using a guidance parameter associated with variance guidance to alter the statistical uncertainty of the denoising process. By adjusting the variance, the diffusion system 202 can regulate the precision and consistency of the modifications, ensuring that the generated initial latent space representation 102 and/or the modified latent space representation 106 remain within stable boundaries while adhering to the parameters of the prompt 104.

In some embodiments, the guidance signal 210 may include a recurrence parameter that dictates the number of iterations or "passes" the guidance signal 210 is applied to a single initial latent space representation 102 and/or the modified latent space representation 106 within a given timestep. By applying a recurrence parameter to the guidance signal 210, the diffusion system 202 can amplify the corrective influence of the guidance signal 210 for a predetermined number of iterations.

After the diffusion system 202 receives the guidance signal 210, the diffusion system 202 may receive another initial latent space representation 102. The diffusion system 202 may receive the modified latent space representation 106 generated at timestep M+N, where N is greater than or equal to 0, repeating the process to generate a further refined modified latent space representation 106. Upon reaching a final timestep or at the conclusion of the process, the diffusion system 202 may transmit the final modified latent space representation 106 for further processing. In some embodiments, the diffusion system 202 can include a decoder configured to receive and process the final modified latent space representation 106. For example, the decoder may transform the final modified latent space representation 106 into a perceptible asset, such as an audio or visual content asset, that reflects the specific modifications steered by the guidance signal 210.

In some embodiments, the latent-control head model 204 can be initialized through a supervised or semi-supervised training process. During a training phase, a set of training content (e.g., a plurality of reference assets) may be processed to generate a corresponding modified latent space representation 106 for a specific feature of the training content. For a given instance of training content, the latent-control head model 204 may generate a predicted feature state 206 based at least in part on the associated modified latent space representation 106. The latent-control head model 204, or other system described herein, may then determine a difference (e.g., a mathematical loss or distance metric) between this predicted feature state 206 and a ground-truth target state, where the ground-truth represents the known, objective value of the targeted feature within that specific training instance. The parameters of the latent-control head model 204 can then be updated based on this difference through a backpropagation process. By minimizing this difference across the training set, the latent-control head model 204 can learn to accurately project and disentangle specific features from the high-dimensional latent space into the lower-dimensional feature domain.

During the training of the latent-control head model 204, the weights and parameters of the primary generative model (i.e., the diffusion system 202) remain unmodified. This decoupled training approach can ensure that the latent-control head model 204 functions as a lightweight, modular observer that learns to interpret the internal logic of the primary model without causing model drift or "catastrophic forgetting" of the primary model's original capabilities. Consequently, the training of the latent-control head model 204 can be computationally efficient and can allow the controllable guidance model 100 to remain flexible across various generative tasks because the latent-control head model 204 can function as a “plug-and-play” component that can be independently swapped or combined to target different features without needing to retrain or modify the primary model of the diffusion system 202.

The training phase of the latent-control head model 204 may specifically incorporate noise to address the high-dimensional complexity of stochastic or Gaussian noise within the latent manifold. In other words, the latent-control head model 204 can be trained to “see” and recognize specific structural patterns within the data while it is still in a chaotic or incomplete state, rather than waiting for the data to be fully cleaned or reconstructed. Unlike conventional models trained only on clean data, the latent-control head model 204 can be exposed to varying levels of noise injected into the training latent space representations during training. The addition of varying levels of noise can simulate the actual conditions of the iterative denoising process. By learning to identify and predict objective features from these noisy states, the latent-control head model 204 can become capable of providing accurate guidance at the earliest stages of the process when the modified latent space representations 106 are particularly noisy.

In some embodiments, the latent-control head model 204 may utilize a backward-simulated noise conditioning technique to match the specific noise distribution encountered during inference. In this approach, the latent-control head model 204 can utilize the output generated from a frozen diffusion system 302 so that the latent-control head model 204 may learn the specific internal representation of features unique to that frozen diffusion system 302. Therefore, rather than simulating noise using a generic mathematical distribution (e.g., standard Gaussian noise), the controllable guidance system 100 can execute a "dry run" of the frozen diffusion system 302 to generate complete sampling trajectories. These sampling trajectories may be generated for each timestep or for a subset of the total timesteps executed by the frozen diffusion system 302. The latent-control head model 204 may be trained to map these specific intermediate modified latent space representations 106 to ground-truth feature states derived from the final generated output of the trajectory. Because the intermediate steps executed by the diffusion system 302 during actual sampling often deviate from a perfect Gaussian distribution, training on these actual trajectories can ensure the latent-control head model 204 is optimized for the "real-world" data manifold and sampling path of a specific instance of the diffusion system 302.

Furthermore, the training objective may incorporate sparsity-aware losses to handle implicitly sparse audio features (e.g., pitch probabilities where only a single frequency bin is active). In such cases, the latch-control head model 204 may define a threshold for non-activating features and average the "below-threshold" and "above-threshold" losses. This heuristic can upweight the importance of sparsely activating features, thereby ensuring the latent-control head model 204 can maintain high sensitivity to critical structural changes (like a note transition) even within a high-dimensional, noisy latent environment.

The training of the latent-control head model 204 may include targeted objective mapping to achieve specific feature disentanglement. The training may focus the latent-control head model 204 to map the broad, high-dimensional modified latent space representation 106 into a specific, lower-dimensional target feature state. This training can allow the latent-control head model 204 to isolate the subspace related to a single feature or attribute, such as pitch or rhythm, from other unrelated characteristics within the modified latent space representation 106. This may be accomplished by training the latent-control head model 204 with pairs of noisy latent space representations and their corresponding objective ground-truth labels. In some embodiments, the training may include using a differentiable loss function to minimize the distance between the latent-control head model 204 predicted feature state 206 and the known target feature state.

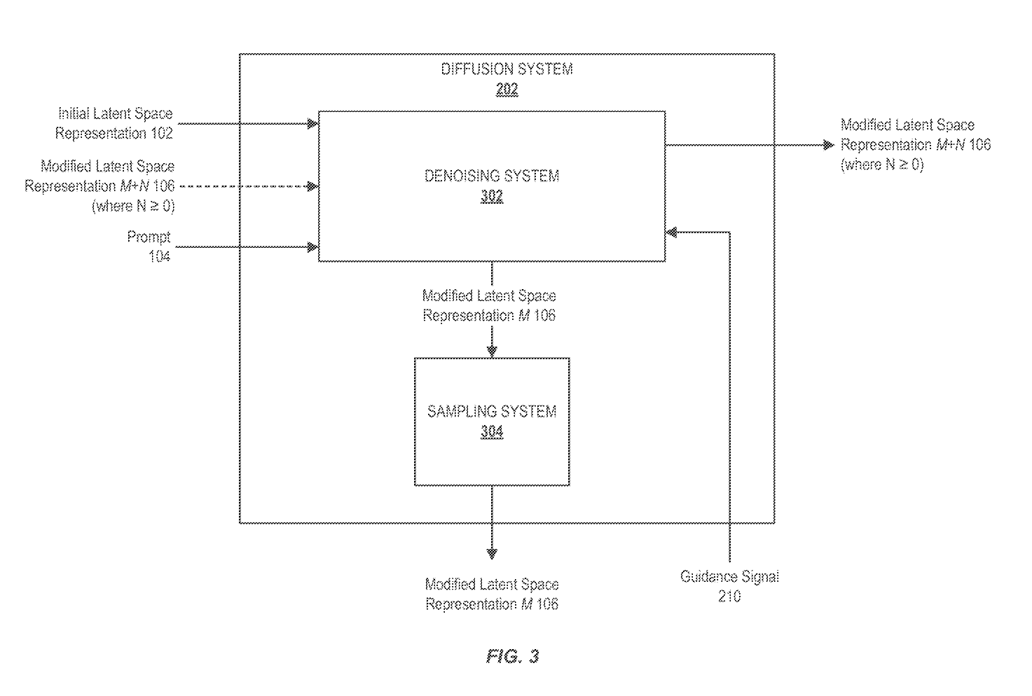

FIG. 3 is a block diagram illustrating an example diffusion system 202 (e.g., diffusion system 202 described above), according to certain embodiments. The diffusion system 202 may include a denoising system 302 and/or a sampling system 304.

The denoising system 302 may receive an initial latent space representation 102 (e.g., initial latent space representation 102 described above), a prompt 104 (e.g., prompt 104 described above), and a guidance signal 210 (e.g., guidance signal 210 described above). At timestep M, the denoising system 302 may generate, based on the initial latent space representation 102 and the prompt 104, a modified latent space representation M 106 (e.g., modified latent space representation 106 described above).

The denoising system 302 may receive a guidance signal 210 (e.g., guidance signal 210 described above). In some embodiments, the denoising system 302 may receive a modified latent space representation 106 (e.g., modified latent space representation 106 described above) generated at timestep M+N, where N is greater than or equal to 0. The denoising system 302 may generate a further refined modified latent space representation 106 based on the prompt 104, guidance signal 210, and/or the modified latent space representation 106 generated at timestep M+N.

For the sake of clarity and to avoid descriptive redundancy, the specific operations and data flows associated with the modified latent space representation 106 at timestep M+N are not explicitly illustrated in every instance. However, it should be understood by one of ordinary skill in the art that the technical descriptions, transformations, and operations explained with reference to the modified latent space representation 106 at timestep M are equally applicable to any modified latent space representation 106 at timestep M+N, where N is greater than or equal to 0. Accordingly, the modified latent space representation 106 may refer to any specific instance or iteration of the modified data as it exists at any timestep M or M+N, where N is greater than or equal to 0.

The denoising system 302 may be configured to process the initial latent space representation 102 through a reverse-diffusion process. The reverse-diffusion process can be iterative. The denoising system 302 can determine an amount of “noise” by processing the initial latent space representation 102 through, for example, a neural network trained to identify Gaussian noise patterns within the latent manifold. The neural network can output a noise estimate tensor corresponding to the initial latent space representation 102 at the current timestep. The denoising system 302 may then perform corrective subtraction by removing a portion of this noise estimate (i.e., “de-noising”) from the initial latent space representation 102, thereby generating the modified latent space representation 106 at timestep M.

The sampling system 304 can be configured to receive the modified latent space representation 106 generated by the denoising system 302 and transmit said representation to the latent-control head model 204. Specifically, the sampling system 304 may receive a representation generated at a specific timestep M. The sampling system 304 may be configured to selectively sample the modified latent space representations 106 generated by the denoising system 302 to maintain manifold integrity. This selective sampling by the sampling system 304 can prevent the modified latent space representation 106 from deviating from the learned data manifold, a risk that may occur if the guidance signal 210 is applied with excessive frequency. Furthermore, selective sampling reduces computational overhead by ensuring that only a subset of the modified latent space representations 106 is processed by the latent-control head model 204, thereby optimizing the balance between steering precision and the overall controllable guidance system 100 performance.

To illustrate an exemplary selective sampling schedule, the sampling system 304 may be configured to sample only a specific segment of the process, such as the first 20 % of the modified latent space representations 106 generated by the denoising system 302. For a process comprising 100 timesteps, for example, the sampling system 304 may transmit only those representations generated from timestep 1 through timestep 20. In other embodiments, the sampling system 304 may employ non-consecutive or interval-based sampling. In such configurations, the sampling system 304 may sample representations generated at every fifth timestep (e.g., timestep 5, 10, 15, and so forth).

Additionally or alternatively, the sampling schedule may include time-variance, such that the sampling system 304 selects only those modified latent space representations 106 corresponding to specific temporal offsets within the content. For example, if the prompt 104 specifies a modification that should only occur during a specific segment of the audio, such as adding a 'distorted' effect to a guitar solo between the thirty-second and forty-second marks, the sampling system 304 may be configured to activate the sampling process only during the timesteps associated with that specific ten-second window. These varied sampling schedules can allow the controllable guidance system 100 to concentrate the influence of the guidance signal 210 during critical or specified phases of the generative process while conserving computational resources during others.

In response to receiving the transmitted modified latent space representations 106 from the sampling system 304, the denoising system 302 may receive a guidance signal 210, as described herein. The denoising system may receive a new initial latent space representation 102. The denoising system may receive the modified latent space representation 106 generated at timestep M+N, where N is greater than or equal to 0, repeating the estimation and guided subtraction processes described herein to generate further refined modified latent space representations 106. Additionally or alternatively, the denoising system 302 may transmit the modified latent space representation 106 for further downstream processing, such as by a decoder.

This iterative process described herein can continue until the initial latent space representation 102 and/or the modified latent space representation 106 reaches a noise-free state that conforms to the requirements or parameters of the prompt 104.

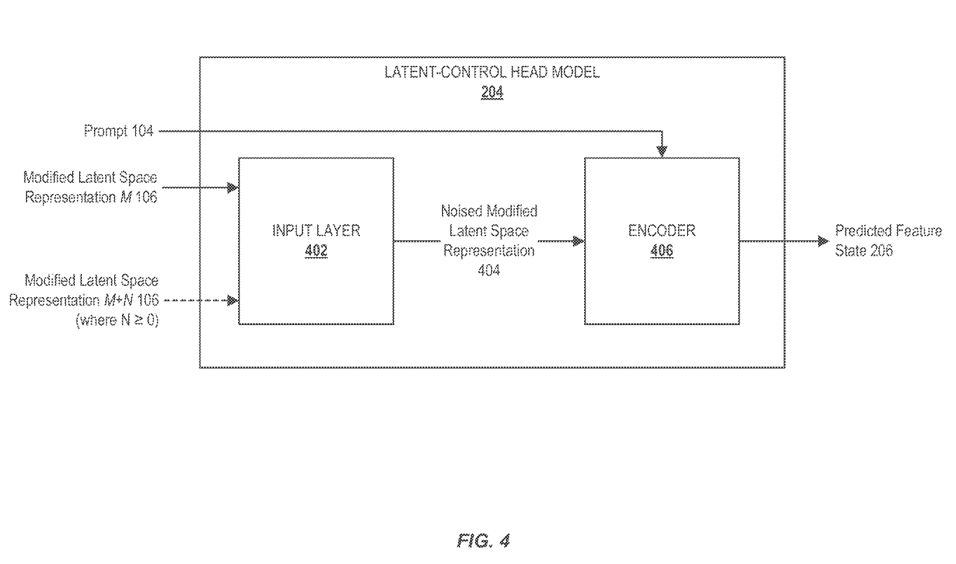

FIG. 4 is a block diagram illustrating an example latent-control head model 204 (e.g., latent-control head model 204 described above), according to certain embodiments. The latent-control head model 204 may include an input layer 402 and/or an encoder 406. The latent-control head model 204 may receive a modified latent space representation 106 for a given timestep. The latent-control head model 204 may generate, based on the modified latent space representation 106, a predicted feature state 206.

In some embodiments, the latent-control head model 204 may receive a prompt 104 (e.g., prompt 104 described above) or may reference content or other assets provided therein prompt 104 that indicate the targeted or desired feature state of the content.

The input layer 402 may receive the modified latent space representation 106 generated at timestep M. The input layer 402 may generate, based on the modified latent space representation 106, a noised modified latent space representation 106. The input layer 402 may optionally receive and process a modified latent space representation 106 generated at a timestep M+N, where N is greater than or equal to 0, as the basis for generating a subsequent noised modified latent space representation 404.

In some embodiments, the input layer 402 may be configured to perform pre-processing functions including, but not limited to, normalization, channel projection, and timestep embedding addition. Timestep embedding addition can include incorporating temporal metadata into the modified latent space representation 106 to provide the encoder 406 with necessary context regarding the specific position of the data within the noise schedule.

Furthermore, the input layer 402 may receive a modified latent space representation 106 that has been previously subjected to a noising process by the diffusion system 202. In such embodiments, the input layer 402 can be configured to ingest the noisy modified latent space representation 106 and perform pre-processing operations, such as normalization and channel projection, to prepare the modified latent space representation 106 for subsequent processing by the encoder 406.

For the sake of clarity and to avoid descriptive redundancy, the specific operations and data flows associated with the modified latent space representation 106 at timestep M+N are not explicitly illustrated in every instance. However, it should be understood by one of ordinary skill in the art that the technical descriptions, transformations, and operations explained with reference to the modified latent space representation 106 at timestep M are equally applicable to any modified latent space representation 106 at timestep M+N, where N is greater than or equal to 0. Accordingly, the modified latent space representation 106 may refer to any specific instance or iteration of the modified data as it exists at any timestep M or M+N, where N is greater than or equal to 0.

In some embodiments, the controllable guidance system 100 may utilize a modular architecture where each distinct type of feature corresponds to a specific, dedicated instance of the latent-control head model 204. For example, a first instance of the latent-control head model 204 may be specialized and trained to identify and project coordinates associated with a first feature (e.g., pitch), while a second, distinct instance of the latent-control head model 204 may be specialized for a second feature (e.g., rhythm). This one-to-one correspondence between feature types and latent-control head model 204 instances can allow for high-precision disentanglement and enables the controllable guidance system 100 to scale its control capabilities by activating the appropriate latent-control head model 204 instance based on the parameters of the prompt 104.

The input layer 402 may add “noise” to the modified latent space representations 106 prior to transmitting the modified latent space representation 106 to the encoder 406. This intentional injection of noise (e.g., Gaussian noise, latent jittering, augmentation, etc.) is performed to improve the robustness and generalization of the encoder 406. Introducing a controlled amount of noise can ensure the encoder 406 does not "overfit" to specific points in the feature subspace of the modified latent space representation 106 but rather learns to identify features across the broader feature subspace. Furthermore, adding noise can enable the encoder 406 to maintain high-fidelity feature extraction even when the denoising process is in its early, noisier stages. This is because the encoder 406 has been trained to identify underlying features amidst significant noise, allowing the encoder 406 to function effectively before the diffusion system 202 has reached a state of high convergence (i.e., produced clearer latent space representations 106).

The encoder 406 may receive prompt 104 and/or the noised modified latent space representation 404. The encoder 406 can be configured to project high-dimensional data into a low-dimensional feature subspace. The encoder 406 may identify a specific subspace within the noised modified latent space representation 404 that corresponds to the targeted or desired feature state of the content indicated in the prompt 104. From these specific identified subspaces, the encoder 406 may then distill the latent data into a predicted feature state 206. In other words, the encoder 406 may analyze the dimensions of the noised modified latent space representation 404 to identify the specific vector direction or manifold coordinates associated with the feature in question.

After isolating the relevant manifold coordinates or vector direction associated with the requested feature, the encoder 406 can project these localized latent dimensions into a lower-dimensional feature space to generate the predicted feature state 206. The projection into the lower-dimensional feature space can serve to disentangle the targeted feature from unrelated latent attributes. Take for example a prompt 104 that specifies that the pitch of a piece of audio content is to be increased. The high-dimensional latent embeddings associated with the audio content can often contain entangled representations in which the pitch is mathematically intertwined with other features in the audio content, such as timbre, rhythm, or spatiality.

To address the entangled representations, the encoder 406 can distill, from the noised modified latent space representation 404, the isolated manifold coordinates or the vector direction for the target feature into a lower-dimensional feature domain. From this projection of the isolated manifold coordinates or the vector direction, the encoder 406 can determine the predicted feature state 206. In one example, where the feature indicated by the prompt 104 is pitch, the subspace of the noised modified latent space representation 404 associated with pitch is isolated and projected into the lower-dimensional feature domain. Within this domain, the predicted feature state 206 can be directly and quantitatively compared to the target feature state associated with the requested pitch, as both states exist within the same dimensional space. Operating within this domain can enable low-resource guidance as it can eliminate the requirement to backpropagate through a decoder to determine the difference between the target feature state and the predicted feature state 206. This dimensionality reduction may also serve to filter out latent 'noise' from unrelated features, ensuring that the resulting guidance signal 210 is highly specific to the requirements of the prompt 104. Consequently, the controllable guidance system 100 can steer the noised modified latent space representation 404 toward the target feature state while preventing unwanted modifications in non-targeted dimensions of the content.

The encoder 406 may transmit the predicted feature state 206 to the diffusion system 202. The predicted feature state 206 may be transmitted as a low-dimensional feature vector or tensor. The encoder 406 can operate iteratively and so may receive a subsequent noised modified latent space representation 404 corresponding to modified latent space representation 106 generated at a timestep M+N, where N is greater than or equal to 0, repeating the process to generate a subsequent guidance signal 210.

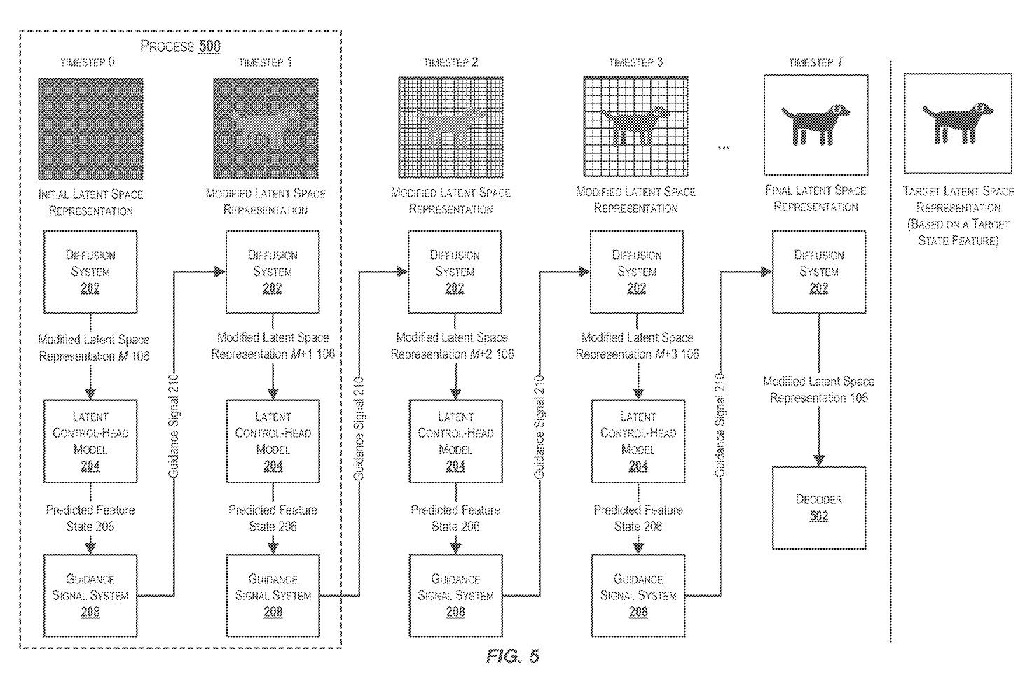

FIG. 5 is a block diagram illustrating an example process 500 using a controllable guidance system 100 (e.g., controllable guidance system 100 described above), according to certain embodiments. FIG. 5 is provided for illustrative purposes to depict the iterative nature of the process 500 and is not intended to be limiting. To visually represent the progression of the controllable guidance system 100, FIG. 5 depicts a representative visual asset (e.g., an image of a dog) that becomes progressively clearer and more refined at each sequential timestep. This visual evolution serves as a proxy to demonstrate the reduction of stochastic noise and the emergence of features steered by a guidance signal 210 (e.g., guidance signal 210 discussed above) as a initial latent space representation 102 (e.g., initial latent space representation 102 discussed above) and/or a modified latent space representation 106 (e.g., modified latent space representation 106 discussed above) converges toward a final perceptible asset.

FIG. 5 depicts an iterative process over timesteps 0 to timestep T, where T is any positive whole number. The process 500, as denoted by the dashed lines, encompasses operations at timestep 0 and at timestep 1. For the sake of clarity, the operations discussed and encompassed in process 500 are applicable to any timestep shown.

At timestep 0, a diffusion system 202 (e.g., diffusion system 202 discussed above) may generate a modified latent space representation M 106 based on the initial latent space representation 102 (not shown). The modified latent space representation M 106 can be transmitted to a latent-control head model 204 (e.g., latent-control head model 204 discussed above) for processing, as described herein. The latent-control head model 204 can generate a predicted feature state 206 (e.g., predicted feature state 206 discussed above), as discussed herein. The predicted feature state 206 may be transmitted to a guidance signal system 208 (e.g., guidance signal system 208 discussed above), as discussed herein. The guidance signal system 208 may generate a guidance signal 210 (e.g., guidance signal 210 discussed above), as discussed herein.

The guidance signal 210 generated at timestep 0 may be transmitted to the diffusion system 202, where the process progresses from timestep 0 to timestep 1. The diffusion system 202 may generate, based on the guidance signal 210 generated at timestep 0, a modified latent space representation M+1 106 at timestep 1, as discussed herein. The modified latent space representation M+1 106 can be transmitted to a latent-control head model 204 for processing, as discussed herein. The latent-control head model 204 can generate a predicted feature state 206, as discussed herein. The predicted feature state 206 may be transmitted to a guidance signal system 208, as discussed herein. The guidance signal system 208 may generate a guidance signal 210, as discussed herein.

The guidance signal generated at timestep 1 may be transmitted to the diffusion system 202, wherein the process progresses from timestep 1 to timestep 2. The operations encompassed in process 500 may be repeated for timestep 2. Similarly, the operations may be repeated for timestep 3 and onward until timestep T.

Timestep T can denote the final timestep of the process executed by the controllable guidance system 100. The diffusion system 202 may generate, at timestep T, the final modified latent space representation 106. The final modified latent space representation 106 can be transmitted to the decoder 502. The decoder 502 can transform the final modified latent space representation 106 into a perceptible asset that reflects the culmination of the iterative modifications steered by the controllable guidance system 100. At timestep T, the representative visual asset (e.g., the dog) depicts a significantly denoised output that is substantially aligned with the target latent space representation, the target latent space representation being based on a target state feature. This alignment illustrates that the final asset can embody the target feature state derived from a prompt 104 (e.g., prompt 104 discussed above), effectively concluding the iterative process.

The final timestep T of the process, and thus the conclusion of the controllable guidance process, may be determined by a predetermined number of iterations. This number may be dictated by a numerical value provided to the controllable guidance system 100, such as a parameter provided to the diffusion system 202. In some embodiments, this parameter may be a static value that instructs the diffusion system 202 when to terminate the guidance process and output the final modified latent space representation 106. This parameter may also be indicated by the prompt 104, such as an explicit instruction to terminate the guidance after a specified number of iterations.

In some embodiments, the parameter provided to the controllable guidance system 100 may include a percentage value. In other words, the process may terminate after a specific percentage of the total steps has been completed. For example, during the initial percentage of the total steps, the modified latent space representations 106 may be transmitted to the latent-control head model 204 for guidance. Then, for the remaining percentage of the steps, the modified latent space representations 106 may be processed by the diffusion system 202 without further guidance from the latent-control head model 204, allowing the denoising system 302 to finalize the fine-grained details of the asset.

Additionally or alternatively, the controllable guidance system 100 may utilize a dynamic termination approach where the process concludes when the guidance signal 210, or the difference calculated by the guidance system 208, falls within a specific threshold. For example, if the difference between the predicted feature state 206 and the target feature state is sufficiently minimized, this can indicate that the modified latent space representation 106 has converged toward the desired or target feature state. In this scenario, the controllable guidance system 100 can cease further modifications and transmits the final modified latent space representation 106 for further downstream processing, such as to the decoder 502 for content or asset reconstruction.

### II. METHOD

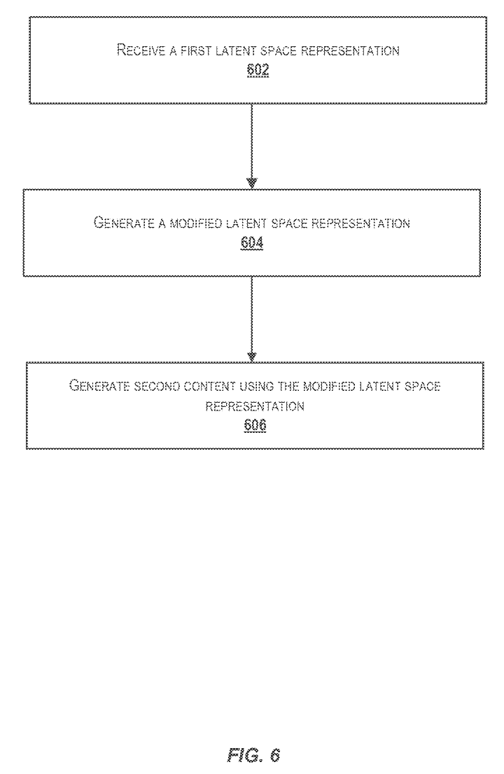

The processing performed using the inference system architecture described above with respect to FIGS. 1-5 may be implemented using a controllable guidance method. Examples of such methods are described below with respect to method 600 as depicted in FIG. 6.

The processing depicted in method 600 and any other FIGS. may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in method 600, and other FIGS. and described herein are intended to be illustrative and non-limiting. Although method 600, and other FIGS., depict the various processing steps occurring in a particular sequence or order, this is not intended to be limiting. In certain alternative embodiments, the processing may be performed in some different order or some steps may also be performed in parallel. It should be appreciated that in alternative embodiments the processing depicted in method 600, and other FIGS., may include a greater number or a lesser number of steps than those depicted in the respective FIGS.

FIG. 6 is a block diagram illustrating an example method 600 of using a controllable guidance system, according to certain embodiments of the present disclosure. The method may be performed by the controllable guidance system 100 described above.

At S602, a first latent space representation (e.g., initial latent space representation 102 described above; modified latent space representation 106 described above) may be received. The first latent space may be generated based in part on inputting a prompt (e.g., prompt 104 descirbed above) indicating a feature of first content to a first model (e.g., diffusion system 202 described above; denoising system 302 described above). In some embodiments, the first model may comprise at least one of a diffusion model, a transformer-based model, or a flow-matching model.

In some embodiments, the first content may comprise at least one of: audio content, image content, video content, or three-dimensional content.

In some embodiments, the feature of first content may correspond to at least one of an audio sample pitch, an audio sample intensity, a rhythmic pattern, a spectral envelope, or a beat of an audio sample.

At S604, a modified latent space representation may be generated (e.g., modified latent space representation 106 described above). The modified latent space representation may be generated by the first model by modifying the first latent space representation. The first model may modify the first latent space representation based at least in part on the feature of the first content. The modified latent space representation can be generated from the first latent space representation independent of generating a waveform.

In some embodiments, the first model may modify the first latent space representation repeatedly for a number of iterations. The number of iterations may be determined by a guidance parameter.

Generating the modified latent space representation by modifying the first latent space representation may comprise generating, based on the first latent space representation, a predicted state (e.g., predicted feature state 206) of the feature in the prompt. The predicted state may correspond to the modified latent space representation. A difference between the predicated state of the feature and a target state of the feature may be determined. A guidance signal (e.g., guidance signal 210 described above) may be generated based on the difference. The first model may modify the first latent space representation based at least in part on the guidance signal to generate the modified latent space representation.

In some embodiments, a scaling factor may be applied to the guidance signal once it has been generated. The applied scaling factor can modify a magnitude of the an effect of the guidance signal on the first latent space representation.

The target state of the feature may be a desired state of the feature indicated by the prompt.

Determining the difference between the predicted state of the feature and the target state of the feature may further comprise calculating a gradient of a distance function relative to the difference between the predicted state and the target state. The distance function may be a differentiable loss function.

In some embodiments, prior to determining the difference between the predicted state of the feature and the target state of the feature, the predicted state of the feature may be modified. The predicted state of the feature may be modified by combining the predicted state of the feature with a noise signal to generate a noisy predicted state of the feature.

The predicted state of the feature may be generated by a second model (e.g., latent-control head model 204 described above). The second model may be configured to receive the first latent space representation and determine the predicted state of the feature based at least in part on the first latent space representation. In some embodiments, a first type of feature may correspond to a first instance of the second model and a second type of feature may correspond to a second instance of a second model. In other words, each distinct type of feature may correspond to a specific, dedicated instance of the second model.

The second model may be trained. The training of the second model may comprise generating, for training content, a modified latent space representation associated with a feature of the training content. The second model may generate a predicted state of the respective feature based at least in part on the modified latent space representation. The second model may determine a difference between the predicted state of the respective feature and a ground-truth target state of the respective feature. The second model may be updated based on the difference. In some embodiments, determining the difference between the predicted state of the respective feature and the ground-truth target of the respective feature may comprise calculating, by the second model, aa gradient of a distance function relative to the difference between the predicted state and the ground-truth target state. In some embodiments, the distance function may be a differentiable loss function

At S606, a second content (e.g., modified latent space representation 106 described above) may be generated using the modified latent space representation. The second content may be different from the first content, wherein the second content represents the feature.

### III. COMPUTER SYSTEM

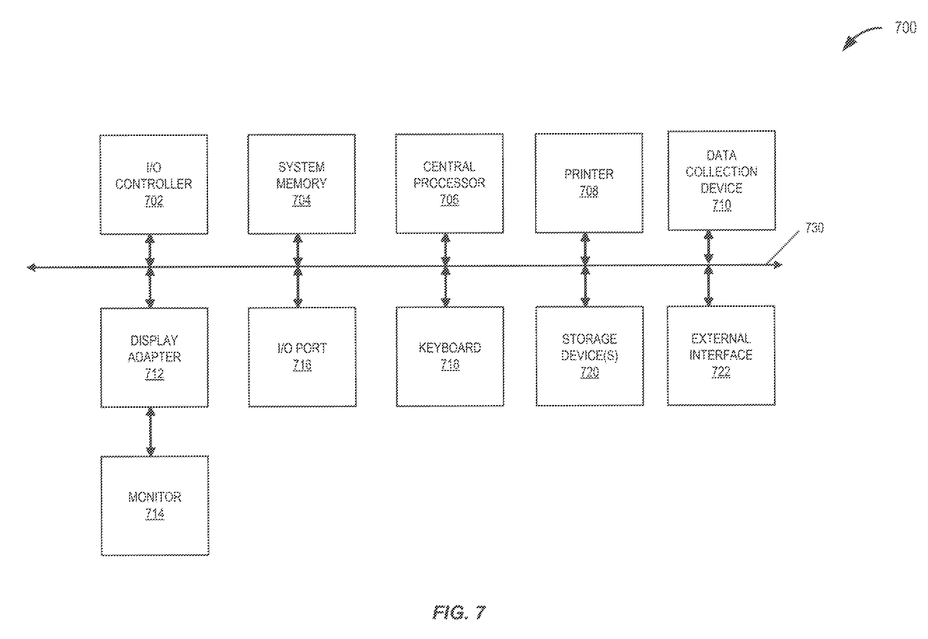

Any of the computer systems mentioned herein may utilize any suitable number of subsystems. Examples of such subsystems are shown in FIG. 7 in computer system 700. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 7 are interconnected via a system bus 730. Additional subsystems such as a printer 708, keyboard 718, storage device(s) 720, monitor 714 (e.g., a display screen, such as an LED), which is coupled to display adapter 712, and others are shown. Peripherals and input/output (I/O) devices, which couple to I/O controller 702, can be connected to the computer system by any number of means known in the art such as input/output (I/O) port 716 (e.g., USB, FireWire^{®}). For example, I/O port 716 or external interface 722 (e.g., Ethernet, Wi-Fi, etc.) can be used to connect computer system 700 to a wide area network such as the Internet, a mouse input device, or a scanner. The interconnection via system bus 730 allows the central processor 706 to communicate with each subsystem and to control the execution of a plurality of instructions from system memory 704 or the storage device(s) 720 (e.g., a fixed disk, such as a hard drive, or optical disk), as well as the exchange of information between subsystems. The system memory 704 and/or the storage device(s) 720 may embody a computer readable medium. Another subsystem is a data collection device 710, such as a camera, microphone, accelerometer, and the like. Any of the data mentioned herein can be output from one component to another component and can be output to the user.

A computer system can include a plurality of the same components or subsystems, e.g., connected together by external interface 722, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communication messages between devices, including at least 100, 200, 500, 1,000, 10,000, 50,000, 100,000, 500,00, or one million communication messages. Such communications can involve at least 1 MB, 10 MB, 100 MB, 1 GB, 10 GB, or 100 GB of data.

A summary of the various embodiments of the invention is provided below as a list of examples. As used below, any reference to a series of examples is to be understood as a reference to each of those examples disjunctively (e.g., "Examples 1-4" is to be understood as "Examples 1, 2, 3, or 4").

Example 1 is a method comprising: receiving a first latent space representation, the first latent space representation generated based at least in part on inputting a prompt indicating a feature of first content to a first model; generating, by the first model, a modified latent space representation by modifying the first latent space representation based at least in part on the feature of the first content; and generating, using the modified latent space representation and the first model, second content that is different from the first content, wherein the second content represents the feature.

Example 2 is the method of example 1, wherein generating the modified latent space representation by modifying the first latent space representation further comprises: generating, based on the first latent space representation, a predicted state of the feature indicated in the prompt, wherein the predicted state corresponds to the modified latent space representation; determining a difference between the predicted state of the feature and a target state of the feature; generating a guidance signal based on the difference; and modifying, by the first model, the first latent space representation based at least in part on the guidance signal to generate the modified latent space representation.

Example 3 is the method of example 2, wherein determining the difference between the predicted state of the feature and the target state of the feature further comprises: calculating a gradient of a distance function relative to the difference between the predicted state and the target state, wherein the distance function is a differentiable loss function.

Example 4 is the method of example 2, wherein the target state of the feature is a desired state of the feature indicated by the prompt.

Example 5 is the method of example 2, wherein prior to determining the difference, the method further comprises: modifying the predicted state of the feature by combining the predicted state of the feature with a noise signal to generate a noisy predicted state of the feature.

Example 6 is the method of example 2, wherein generating the guidance signal further comprises: applying a scaling factor to the guidance signal to modify a magnitude of an effect of the guidance signal on the first latent space representation.

Example 7 is the method of example 2, wherein generating the predicted state of the feature is performed by a second model, the second model configured to: receive the first latent space representation; and determine the predicted state of the feature based at least in part on the first latent space representation.

Example 8 is the method of example 7, wherein a first type of feature corresponds to a first instance of a second model and a second type of feature corresponds to a second instance of a second model.

Example 9 is the method of example 7, wherein training the second model further comprises: generating, for training content, a modified latent space representation associated with a feature of the training content; generating by the second model, a predicted state of the respective feature based at least in part on modified latent space representation; determining by the second model, a difference between the predicted state of the respective feature and a ground-truth target state of the respective feature; and updating the second model based on the difference.

Example 10 is the method of example 9, wherein determining the difference between the predicted state of the respective feature and the ground-truth target state of the respective feature further comprises: calculating by the second model, a gradient of a distance function relative to the difference between the predicted state and the ground-truth target state, wherein the distance function is differentiable loss function.

Example 11 is the method of example 10, wherein modifying the first latent space representation is performed repeatedly for a number of iterations determined by a guidance parameter.

Example 12 is the method of example 1, wherein the modified latent space representation is generated from the first latent space representation independent of generating a waveform.

Example 13 is the method of example 1, wherein the feature corresponds to at least one of: (i) an audio sample pitch , (ii) an audio sample intensity, (iii) a rhythmic pattern, (iv) a spectral envelope, or (v) a beat of an audio sample.

Example 14 is the method of example 1, wherein the first model comprises at least one of: (i) a diffusion model; (ii) a transformer-based model; or (iii) a flow-matching model.

Example 15 is the method of example 1, wherein the first content comprises at least one of: (i) audio content; (ii) image content; (iii) video content; or (iv) three-dimensional content.

Example 16 is a system comprising: one or more storage media storing instructions; and one or more processors configured to execute the instructions to cause the system to: receive a first latent space representation, the first latent space representation generated based at least in part on inputting a prompt indicating a feature of first content to a first model; generate, by the first model, a modified latent space representation by modifying the first latent space representation based at least in part on the feature of the first content; and generate, using the modified latent space representation and the first model, second content that is different from the first content, wherein the second content represents the feature.

Example 17 is the system of example 16, wherein generating the modified latent space representation by modifying the first latent space representation further causes the system to: generate, based on the first latent space representation, a predicted state of the feature indicated in the prompt, wherein the predicted state corresponds to the modified latent space representation; determine a difference between the predicted state of the feature and a target state of the feature; generate a guidance signal based on the difference; and modify, by the first model, the first latent space representation based at least in part on the guidance signal to generate the modified latent space representation.

Example 18 is the system of example 17 wherein determining the difference between the predicted state of the feature and the target state of the feature further causes the system to: calculate a gradient of a distance function relative to the difference between the predicted state and the target state, wherein the distance function is a differentiable loss function.

Example 19 is the system of example 17, wherein the target state of the feature is a desired state of the feature indicated by the prompt.

Example 20 is the system of example 17, wherein prior to determining the difference, the instructions further cause the system to: modify the predicted state of the feature by combining the predicted state of the feature with a noise signal to generate a noisy predicted state of the feature.

Example 21 is the system of example 17, wherein generating the guidance signal further causes the system to: apply a scaling factor to the guidance signal to modify a magnitude of an effect of the guidance signal on the first latent space representation.

Example 22 is the system of example 17, wherein generating the predicted state of the feature is performed by a second model, the second model configured to: receive the first latent space representation; and determine the predicted state of the feature based at least in part on the first latent space representation.

Example 23 is the system of example 22, wherein a first type of feature corresponds to a first instance of a second model and a second type of feature corresponds to a second instance of a second model.

Example 24 is the system of example 22, wherein training the second model further causes the system to: generate, for training content, a modified latent space representation associated with a feature of the training content; generate by the second model, a predicted state of the respective feature based at least in part on modified latent space representation; determine by the second model, a difference between the predicted state of the respective feature and a ground-truth target state of the respective feature; and update the second model based on the difference.

Example 25 is the system of example 24, wherein determining the difference between the predicted state of the respective feature and the ground-truth target state of the respective feature further causes the system to: calculate by the second model, a gradient of a distance function relative to the difference between the predicted state and the ground-truth target state, wherein the distance function is differentiable loss function.

Example 26 is the system of example 16 wherein modifying the first latent space representation is performed repeatedly for a number of iterations determined by a guidance parameter.

Example 27 is the system of example 16, wherein the modified latent space representation is generated from the first latent space representation independent of generating a waveform.

Example 28 is the system of example 16, wherein the feature corresponds to at least one of: (i) an audio sample pitch , (ii) an audio sample intensity, (iii) a rhythmic pattern, (iv) a spectral envelope, or (v) a beat of an audio sample.

Example 29 is the system of example 16, wherein the feature corresponds to at least one of: (i) an audio sample pitch , (ii) an audio sample intensity, (iii) a rhythmic pattern, (iv) a spectral envelope, or (v) a beat of an audio sample.

Example 30 is the system of example 16, wherein the first content comprises at least one of: (i) audio content; (ii) image content; (iii) video content; or (iv) three-dimensional content.

Example 31 is one or more non-transitory computer-readable storage media storing instructions that, upon execution by one or more processors of a system, cause the system to perform operations comprising: receiving a first latent space representation, the first latent space representation generated based at least in part on inputting a prompt indicating a feature of first content to a first model; generating, by the first model, a modified latent space representation by modifying the first latent space representation based at least in part on the feature of the first content; and generating, using the modified latent space representation and the first model, second content that is different from the first content, wherein the second content represents the feature.

Example 32 is the non-transitory computer-readable storage media of example 31, wherein generating the modified latent space representation by modifying the first latent space representation further comprises: generating, based on the first latent space representation, a predicted state of the feature indicated in the prompt, wherein the predicted state corresponds to the modified latent space representation; determining a difference between the predicted state of the feature and a target state of the feature; generating a guidance signal based on the difference; and modifying, by the first model, the first latent space representation based at least in part on the guidance signal to generate the modified latent space representation.

Example 33 is the non-transitory computer-readable storage media of example 32, wherein determining the difference between the predicted state of the feature and the target state of the feature further comprises: calculating a gradient of a distance function relative to the difference between the predicted state and the target state, wherein the distance function is a differentiable loss function.

Example 34 is the non-transitory computer-readable storage media of example 32, wherein the target state of the feature is a desired state of the feature indicated by the prompt.

Example 35 is the non-transitory computer-readable storage media of example 32, wherein prior to determining the difference, the method further comprises: modifying the predicted state of the feature by combining the predicted state of the feature with a noise signal to generate a noisy predicted state of the feature.

Example 36 is the non-transitory computer-readable storage media of example 32, wherein generating the guidance signal further comprises: applying a scaling factor to the guidance signal to modify a magnitude of an effect of the guidance signal on the first latent space representation.

Example 37 is the non-transitory computer-readable storage media of example 32, wherein generating the predicted state of the feature is performed by a second model, the second model configured to: receive the first latent space representation; and determine the predicted state of the feature based at least in part on the first latent space representation.

Example 38 is the non-transitory computer-readable storage media of example 37, wherein a first type of feature corresponds to a first instance of a second model and a second type of feature corresponds to a second instance of a second model.

Example 39 is the non-transitory computer-readable storage media of example 37, wherein training the second model further comprises: generating, for training content, a modified latent space representation associated with a feature of the training content; generating by the second model, a predicted state of the respective feature based at least in part on modified latent space representation; determining by the second model, a difference between the predicted state of the respective feature and a ground-truth target state of the respective feature; and updating the second model based on the difference.

Example 40 is the non-transitory computer-readable storage media of example 39, wherein determining the difference between the predicted state of the respective feature and the ground-truth target state of the respective feature further comprises: calculating by the second model, a gradient of a distance function relative to the difference between the predicted state and the ground-truth target state, wherein the distance function is differentiable loss function.

Example 41 is the non-transitory computer-readable storage media of example 40, wherein modifying the first latent space representation is performed repeatedly for a number of iterations determined by a guidance parameter.

Example 42 is the non-transitory computer-readable storage media of example 31, wherein the modified latent space representation is generated from the first latent space representation independent of generating a waveform.

Example 43 is the non-transitory computer-readable storage media of example 31, wherein the feature corresponds to at least one of: (i) an audio sample pitch , (ii) an audio sample intensity, (iii) a rhythmic pattern, (iv) a spectral envelope, or (v) a beat of an audio sample.

Example 44 is the non-transitory computer-readable storage media of example 31, wherein the first model comprises at least one of: (i) a diffusion model; (ii) a transformer-based model; or (iii) a flow-matching model.

Example 45 is the non-transitory computer-readable storage media of example 31, wherein the first content comprises at least one of: (i) audio content; (ii) image content; (iii) video content; or (iv) three-dimensional content.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. The computations can be performed in parallel by the different processing units and/or different processing threads of a single processing unit. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such devices. In addition, the order of operations may be re-arranged. A process can be terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Such programs may also be encoded and transmitted using carrier signals adapted for transmission via wired, optical, and/or wireless networks conforming to a variety of protocols, including the Internet. As such, a computer readable medium according to an embodiment of the disclosed techniques may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. As examples, a time constraint may be 30 seconds, 1 minute, 10 minutes, 30 minutes, 1 hour, 4 hours, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The above description is illustrative and is not restrictive. Many variations of the disclosed will become apparent to those skilled in the art upon review of the disclosure. The scope of the disclosed should, therefore, be determined not with reference to the above description, but instead should be determined with reference to the pending claims along with their full scope or equivalents.

One or more features from any embodiment may be combined with one or more features of any other embodiment without departing from the scope of the disclosed.

A recitation of "a," "an" or "the" is intended to mean "one or more" unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted as prior art. Where a conflict exists between the instant application and a reference provided herein, the instant application shall dominate.

What is claimed is:

1. A system comprising:
one or more storage media storing instructions; and
one or more processors configured to execute the instructions to cause the system to:
receive a first latent space representation, the first latent space representation generated based at least in part on inputting a prompt indicating a feature of first content to a first model;
generate, by the first model, a modified latent space representation by modifying the first latent space representation based at least in part on the feature of the first content; and
generate, using the modified latent space representation and the first model, second content that is different from the first content, wherein the second content represents the feature.

2. The system of claim 1, wherein generating the modified latent space representation by modifying the first latent space representation further causes the system to:
generate, based on the first latent space representation, a predicted state of the feature indicated in the prompt, wherein the predicted state corresponds to the modified latent space representation;
determine a difference between the predicted state of the feature and a target state of the feature;
generate a guidance signal based on the difference; and
modify, by the first model, the first latent space representation based at least in part on the guidance signal to generate the modified latent space representation.

3. The system of claim 2, wherein determining the difference between the predicted state of the feature and the target state of the feature further causes the system to:
calculate a gradient of a distance function relative to the difference between the predicted state and the target state, wherein the distance function is a differentiable loss function.

4. The system of claim 2, wherein the target state of the feature is a desired state of the feature indicated by the prompt.

5. The system of claim 2, wherein prior to determining the difference, the instructions further cause the system to:
modify the predicted state of the feature by combining the predicted state of the feature with a noise signal to generate a noisy predicted state of the feature.

6. The system of claim 2, wherein generating the guidance signal further causes the system to:
apply a scaling factor to the guidance signal to modify a magnitude of an effect of the guidance signal on the first latent space representation.

7. The system of claim 2, wherein generating the predicted state of the feature is performed by a second model, the second model configured to:
receive the first latent space representation; and
determine the predicted state of the feature based at least in part on the first latent space representation.

8. The system of claim 7, wherein a first type of feature corresponds to a first instance of a second model and a second type of feature corresponds to a second instance of a second model.

9. The system of claim 7, wherein training the second model further causes the system to:
generate, for training content, a modified latent space representation associated with a feature of the training content;
generate by the second model, a predicted state of the respective feature based at least in part on modified latent space representation;
determine by the second model, a difference between the predicted state of the respective feature and a ground-truth target state of the respective feature; and
update the second model based on the difference.

10. The system of claim 9, wherein determining the difference between the predicted state of the respective feature and the ground-truth target state of the respective feature further causes the system to:
calculate by the second model, a gradient of a distance function relative to the difference between the predicted state and the ground-truth target state, wherein the distance function is differentiable loss function.

11. The system of claim 1, wherein modifying the first latent space representation is performed repeatedly for a number of iterations determined by a guidance parameter.

12. The system of claim 1, wherein the modified latent space representation is generated from the first latent space representation independent of generating a waveform.

13. The system of claim 1, wherein the feature corresponds to at least one of: (i) an audio sample pitch , (ii) an audio sample intensity, (iii) a rhythmic pattern, (iv) a spectral envelope, or (v) a beat of an audio sample.

14. The system of claim 1, wherein the first model comprises at least one of: (i) a diffusion model; (ii) a transformer-based model; or (iii) a flow-matching model.

15. The system of claim 1, wherein the first content comprises at least one of: (i) audio content; (ii) image content; (iii) video content; or (iv) three-dimensional content.

16. A method comprising:
receiving a first latent space representation, the first latent space representation generated based at least in part on inputting a prompt indicating a feature of first content to a first model;
generating, by the first model, a modified latent space representation by modifying the first latent space representation based at least in part on the feature of the first content; and
generating, using the modified latent space representation and the first model, second content that is different from the first content, wherein the second content represents the feature.

17. The method of claim 16, wherein generating the modified latent space representation by modifying the first latent space representation further comprises:
generating, based on the first latent space representation, a predicted state of the feature indicated in the prompt, wherein the predicted state corresponds to the modified latent space representation;
determining a difference between the predicted state of the feature and a target state of the feature;
generating a guidance signal based on the difference; and
modifying, by the first model, the first latent space representation based at least in part on the guidance signal to generate the modified latent space representation.

18. The method of claim 17, wherein determining the difference between the predicted state of the feature and the target state of the feature further comprises:
calculating a gradient of a distance function relative to the difference between the predicted state and the target state, wherein the distance function is a differentiable loss function.

19. One or more non-transitory computer-readable storage media storing instructions that, upon execution by one or more processors of a system, cause the system to perform operations comprising:
receiving a first latent space representation, the first latent space representation generated based at least in part on inputting a prompt indicating a feature of first content to a first model;
generating, by the first model, a modified latent space representation by modifying the first latent space representation based at least in part on the feature of the first content; and
generating, using the modified latent space representation and the first model, second content that is different from the first content, wherein the second content represents the feature.

20. The one or more non-transitory computer-readable storage media of claim 19, wherein operations for generating the modified latent space representation by modifying the first latent space representation further comprise:
generating, based on the first latent space representation, a predicted state of the feature indicated in the prompt, wherein the predicted state corresponds to the modified latent space representation;
determining a difference between the predicted state of the feature and a target state of the feature;
generating a guidance signal based on the difference; and
modifying, by the first model, the first latent space representation based at least in part on the guidance signal to generate the modified latent space representation.
